(19) United States
(12) Patent Application Publication
(10) Pub. No.: US 2025/0263125 A1
(43) Pub. Date: Aug. 21, 2025

(54) ELONGATED VEHICLE BODY PANEL AND VEHICLE BODY STRUCTURE

(71) Applicants: SUBARU CORPORATION, Tokyo (JP); TOA INDUSTRIES CO., LTD., Gunma (JP)

(72) Inventors: Toshifumi TATSUMI, Tokyo (JP); Takahiro YAMAKAWA, Gunma (JP); Shinya SAITO, Gunma (JP); Yasuhiro KAMIOKA, Gunma (JP)

(73) Assignees: SUBARU CORPORATION, Tokyo (JP); TOA INDUSTRIES CO., LTD., Gunma (JP)

(21) Appl. No.: 19/022,019

(22) Filed: Jan. 15, 2025

(30) Foreign Application Priority Data
Feb. 15, 2024 (JP) 2024-021563

(51) Int. Cl. B62D 25/04

(52) U.S. Cl. CPC B62D 25/04

(57) ABSTRACT

An elongated vehicle body panel formed by press working includes a flat general portion extending in a longitudinal direction, a pair of ridgeline forming portions formed by bending two ends of the general portion in a width direction and forming a pair of ridgelines together with the general portion, and square seat surface portions disposed at an interval in the longitudinal direction on the general portion, the square seat surface portions protruding in a thickness direction and having a square shape in a plan view. Each of the square seat surface portions has a pair of outer edge portions in the width direction that extend along the ridgelines in a vicinity of the ridgelines and a pair of outer edge portions in the longitudinal direction that respectively couple corresponding two ends of the outer edge portions in the width direction.

### CROSS-REFERENCE TO RELATED APPLICATIONS

The present application claims priority from Japanese Patent Application No. 2024-021563 filed on Feb. 15, 2024, the entire contents of which are hereby incorporated by reference.

The present disclosure relates to an elongated vehicle body panel formed by press working and a vehicle body structure including the same.

An elongated panel extending in an extending direction of a framework part such as a pillar portion, a roof rail portion, and a side sill portion of a vehicle body of an automobile is used as disclosed, for example, in Japanese Unexamined Patent Application Publication JP-A 2020-001653. JP-A 2020-001653 describes that a center pillar portion includes an elongated outer panel constituting an outer portion in a vehicle width direction, an elongated inner panel constituting an inner portion in the vehicle width direction, and a hinge reinforcement disposed inside the outer panel. In JP-A 2020-001653, the inner panel, the outer panel, and the hinge reinforcement are each formed by press working.

The hinge reinforcement of JP-A 2020-001653 has a U-shaped section, and includes a top plate portion in a central position in a width direction and a pair of vertical wall portions bent and extending from ridgelines of the top plate portion at two ends in the width direction. The top plate portion is provided with a plurality of welding protrusions protruding to an outer side in the vehicle width direction by a prescribed height, and the welding protrusions are disposed intermittently along a vehicle upper-lower direction. The welding protrusion has a planar shaped outer surface serving as a welding seat surface. The welding protrusion is formed in a semicircular shape or a circular shape, and may also be formed in various shapes such as a rectangular shape, a triangular shape, an elliptical shape, and a hexagonal shape.

Since the hinge reinforcement of JP-A 2020-001653 is formed by press working, tensile stress is generated in the ridgeline formed by the top plate portion and the vertical wall portion during press working. When tensile stress is generated in a ridgeline in a longitudinal direction of an elongated vehicle body panel, a springback amount after press working may be large.

### SUMMARY

According to an embodiment of the disclosure, an elongated vehicle body panel includes a flat general portion, a pair of ridgelines forming portions, square seat surface portions. The elongated vehicle body panel formed by press working, the elongated vehicle body panel includes a flat general portion extending in a longitudinal direction, a pair of ridgelines forming portions formed by bending two ends of the general portion in a width direction and forming a pair of ridgelines together with the general portion, and square seat surface portions disposed at an interval in the longitudinal direction on the general portion, each of the square seat surface portions protruding in a thickness direction and having a square shape in a plan view. The each of the square seat surface portions has a pair of outer edge portions in the width direction that extend along the ridgelines in a vicinity of the ridgelines and a pair of outer edge portions in the longitudinal direction that respectively connect corresponding two ends of the outer edge portions in the width direction.

According to an embodiment of the disclosure, an elongated vehicle body panel includes a flat general portion, a first flange portion, a first ridgeline between the flat general portion and the first flange portion, a wall portion, a second ridgeline between the flat general portion and the wall portion, and square protrusions. The flat general portion extends in a longitudinal direction. The first flange portion is provided in a first side of the flat general portion in a width direction intersecting the longitudinal direction. The wall portion is provided in a second side of the flat general portion in the width direction. The square protrusions are disposed at an interval in the longitudinal direction on the flat general portion, each of the square protrusions protruding in a thickness direction and having a square shape in a plan view. The each of the square protrusions has a first outer edge, a second outer edge, and a pair of third and fourth outer edges. The first outer edge extends along the first ridgeline in a vicinity of the first ridgeline, and the second outer edge extends along the second ridgeline in a vicinity of the second ridgeline. The pair of third and fourth outer edges couple corresponding two ends of the first outer edge and second outer edge.

### BRIEF DESCRIPTION OF DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic perspective view of a vehicle body according to an embodiment of the present disclosure;

FIG. 2 is a side view of an elongated vehicle body panel;

FIG. 3 is a front sectional view of the elongated vehicle body panel;

FIG. 4 is an enlarged side view of a part of the elongated vehicle body panel;

FIG. 5 is a sectional view taken along a line C-C of FIG. 4; and

FIG. 6 is a sectional view taken along a line D-D of FIG. 4.

### DETAILED DESCRIPTION

It is desirable to provide an elongated vehicle body panel and a vehicle body structure including the elongated vehicle panel that makes it possible to reduce a springback amount. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

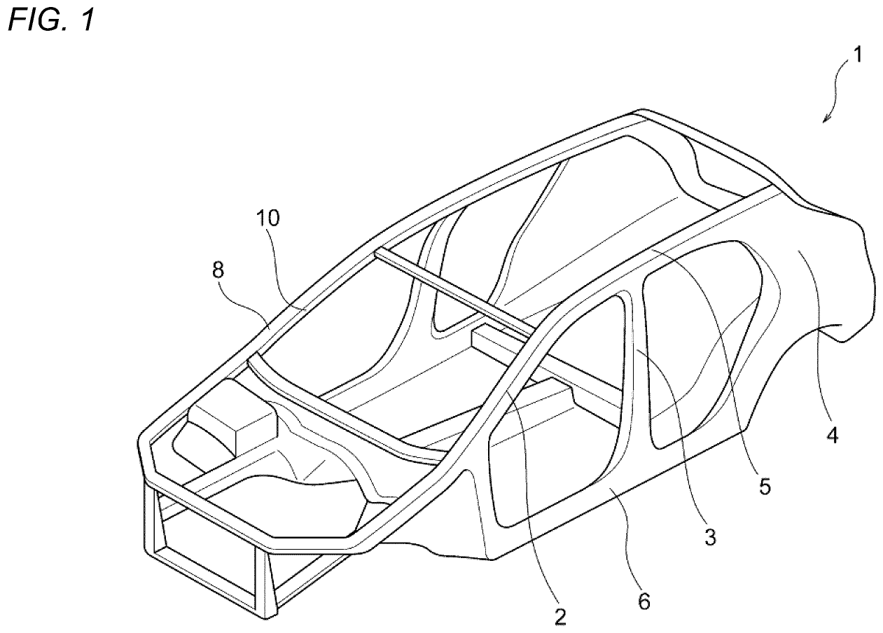

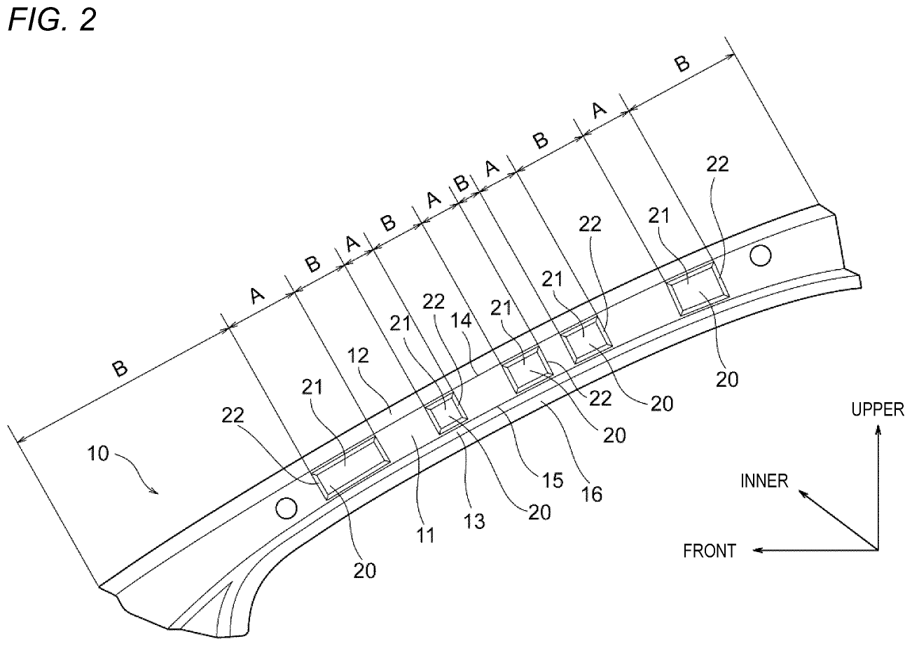

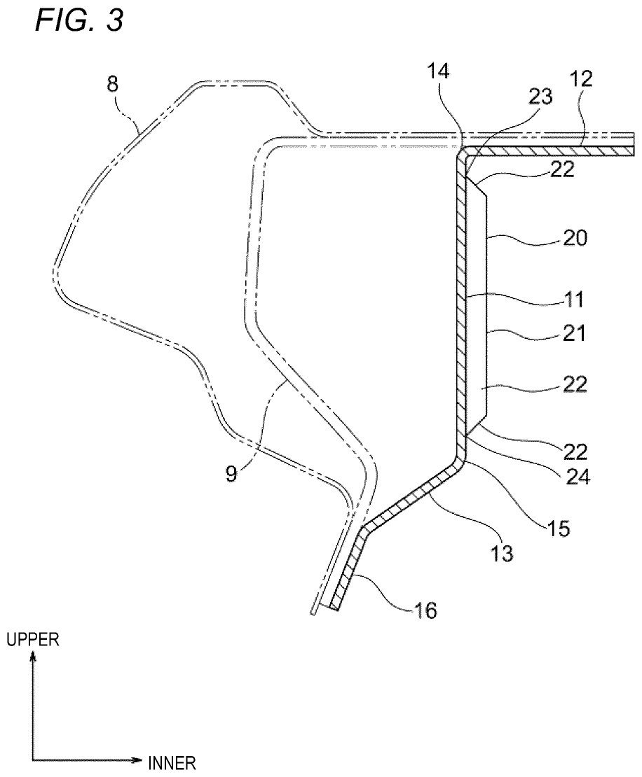

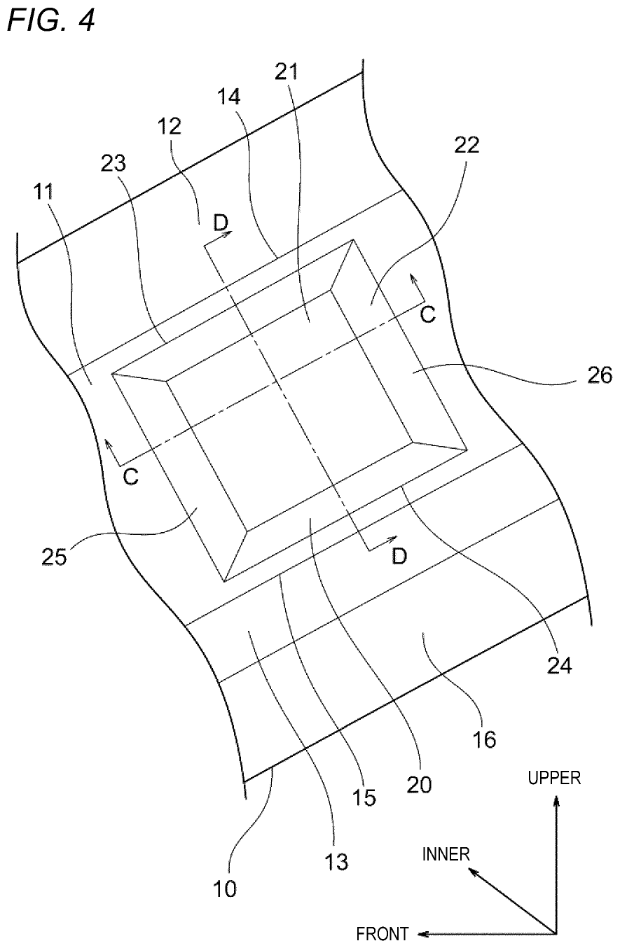

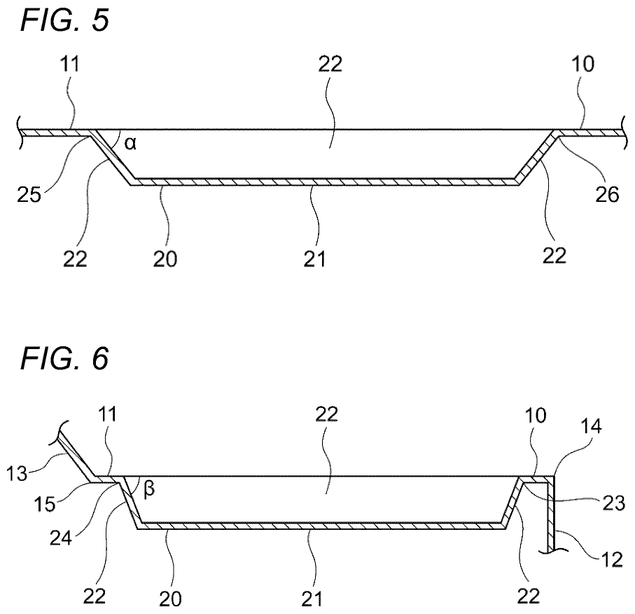

FIGS. 1 to 6 illustrate an embodiment of the present disclosure, in which FIG. 1 is a schematic perspective view of a vehicle body, FIG. 2 is a side view of an elongated vehicle body panel, FIG. 3 is a front sectional view of the elongated vehicle body panel, FIG. 4 is an enlarged side view of a part of the elongated vehicle body panel, FIG. 5 is a sectional view taken along a line C-C of FIG. 4, and FIG. 6 is a sectional view taken along a line D-D of FIG. 4. FIG. 2 is a side view of an elongated vehicle body panel of an A-pillar portion on a vehicle right side, in which a paper front side is an inner side in a vehicle width direction.

An elongated vehicle body panel 10 according to the present embodiment is formed by press working and used in an automobile. As illustrated in FIG. 1, a vehicle body 1 of an automobile includes an A-pillar portion 2, a B-pillar portion 3, a C-pillar portion 4, a roof rail portion 5, a side sill portion 6, and the like. The elongated vehicle body panel 10 according to the present embodiment is a high tensile strength steel plate having a tensile strength of 1180 MPa or more, and is used for the A-pillar portion 2. For example, the elongated vehicle body panel 10 is assembled to the vehicle body 1 such that a longitudinal direction is substantially an extending direction of the A-pillar portion 2, a width direction is an upper-lower direction, and a thickness direction is a vehicle width direction. As illustrated in FIG. 1, in the present embodiment, the A-pillar portion 2 substantially inclines forward and downward and extends in a front-rear direction.

As illustrated in FIG. 2, the elongated vehicle body panel 10 extends in the extending direction of the A-pillar portion 2, and includes a flat general portion 11 extending in the longitudinal direction, a first flange portion 12 formed by bending one end of the general portion 11 in the width direction, and a wall portion 13 formed by bending the other end of the general portion 11 in the width direction. The elongated vehicle body panel 10 has a freely selected plate thickness, and may be, for example, 1.0 mm or more and 2.0 mm or less, and is 1.4 mm in the present embodiment. In the present embodiment, the first flange portion 12 and the wall portion 13 serving as a pair of ridgeline forming portions form a first ridgeline 14 and a second ridgeline 15 together with the general portion 11.

As illustrated in FIG. 3, when the elongated vehicle body panel 10 is assembled to the vehicle body 1, in a front section, the general portion 11 extends in the upper-lower direction, the first flange portion 12 extends to an inner side in the vehicle width direction from an upper end of the general portion 11, and the wall portion 13 inclines downward and extends to an outer side in the vehicle width direction from a lower end of the general portion 11. That is, the first ridgeline 14 protrudes obliquely upward to the outer side in the vehicle width direction, and the second ridgeline 15 protrudes obliquely downward to the inner side in the vehicle width direction. In the present embodiment, the elongated vehicle body panel 10 includes a second flange portion 16 extending downward from an inner end of the wall portion 13 in the vehicle width direction.

As illustrated in FIG. 2, the elongated vehicle body panel 10 includes a plurality of square seat surface portions 20 that are formed at intervals in the longitudinal direction on the general portion 11 and protrude in the thickness direction on the general portion 11. In the present embodiment, the square seat surface portion 20 protrudes to the inner side in the vehicle width direction, has a square shape in a plan view, and is provided in five positions on the general portion 11. As illustrated in FIG. 4, the square seat surface portion 20 includes a flat seat surface body 21 at a center in a plan view, and an inclining portion 22 that is formed around the seat surface body 21 and connects the seat surface body 21 and the general portion 11. In the present embodiment, as illustrated in FIGS. 5 and 6, the seat surface body 21 has a protruding height from the general portion 11 that is greater than a plate thickness of the elongated vehicle body panel 10. The square seat surface portion 20 is freely used for various applications, and may be used as, for example, a harness attachment point, a trim attachment point, a positioning hole forming portion, or a bracket position correction portion. Further, the seat surface body 21 may be formed with a hole as necessary.

As illustrated in FIG. 4, the square seat surface portion 20 includes a first linear edge portion 23 and a second linear edge portion 24 that extend along the first ridgeline 14 and the second ridgeline 15 in a vicinity of the first ridgeline 14 and the second ridgeline 15, and a pair of third linear edge portion 25 and fourth linear edge portion 26 that respectively connect corresponding two ends of the first linear edge portion 23 and the second linear edge portion 24 in the longitudinal direction. The first and second linear edge portions 23 and 24 as a pair of outer edge portions in the width direction and the third and fourth linear edge portions 25 and 26 as a pair of outer edge portions in the longitudinal direction constitute an outer edge of the inclining portion 22. In the present embodiment, the square seat surface portion 20 is formed in a rectangular shape in a plan view, and the third linear edge portion 25 and the fourth linear edge portion 26 are orthogonal to the ridgelines 14 and 15.

Here, inclination angles α and β (see FIGS. 5 and 6) of the inclining portion 22 relative to the general portion 11 and the seat surface body 21 are freely selected, and the first inclination angle α of the inclining portion 22 located at an end portion of the seat surface body 21 in the longitudinal direction is set in a range in which no defect such as a crack occurs during molding, and the second inclination angle β of the inclining portion 22 located at an end portion of the seat surface body 21 in the width direction is determined in consideration of stress acting on the ridgelines 14 and 15. For example, the first inclination angle α is 30 degrees or more, and the second inclination angle β is 45 degrees or more. In the present embodiment, the second inclination angle β is larger than the first inclination angle α, and is, for example, 60 degrees. A distance between each of the first linear edge portion 23 and the second linear edge portion 24 and a corresponding one of the first ridgeline 14 and the second ridgeline 15 is also freely selected, and may be, for example, 20% or less of a size of the general portion 11 in the width direction, and is 15% in the present embodiment.

As illustrated in FIG. 3, the elongated vehicle body panel 10 is an inner panel of the A-pillar portion 2, and constitutes a closed section together with an outer panel 8 of the A-pillar portion 2. In the present embodiment, the A-pillar portion 2 further includes a reinforcement panel 9 that divides the closed section in the vehicle width direction. For example, the elongated vehicle body panel 10 is joined to the outer panel 8 serving as a second panel and the reinforcement panel 9 at the first flange portion 12 and the second flange portion 16.

In the elongated vehicle body panel 10 having the above configurations, as illustrated in FIG. 2, a state of stress generated in the first ridgeline 14 and the second ridgeline 15 after press working is different in the longitudinal direction between a seat surface forming section A in which the square seat surface portion 20 is formed adjacent to the ridgelines 14 and 15 and a general section B in which the square seat surface portion 20 is not formed. First, in the general section B, stress caused by bending the first flange portion 12 and the wall portion 13 mainly acts on the general portion 11, and thus tensile stress is generated in the first ridgeline 14 and the second ridgeline 15. On the other hand, in the seat surface forming section A, in addition to bending the first flange portion 12 and the wall portion 13, stress caused by the square seat surface portion 20 protruding from the general portion 11 acts on the general portion 11. Accordingly, compressive stress or tensile stress smaller than that in the general section B is generated in the first ridgeline 14 and the second ridgeline 15. Accordingly, a springback amount after press working can be reduced. Accordingly, a material, a plate thickness, a shape, and the like of the elongated vehicle body panel 10 can be relatively freely selected during vehicle body design, and a period required for forming a mold used for press working can be shortened.

In the present embodiment, compressive stress is generated in the first ridgeline 14 and the second ridgeline 15 in the seat surface forming section A. That is, tensile stress and compressive stress are alternately generated in the general section B and the seat surface forming section A of the first ridgeline 14 and the second ridgeline 15. Accordingly, the section where the tensile stress is generated in the first ridgeline 14 and the second ridgeline 15 can be cut off in the longitudinal direction by the section where the compressive stress is generated, and the springback amount of the elongated vehicle body panel 10 after the bending process can be reduced. In the present embodiment, since the protruding height of the seat surface body 21 from the general portion 11 is greater than the plate thickness of the elongated vehicle body panel 10, compressive stress can be reliably generated in the first ridgeline 14 and the second ridgeline 15.

The above embodiment describes an example in which the present disclosure is applied to the inner panel of the A-pillar portion 2. Alternatively, the present disclosure may be applied to the outer panel 8 and the reinforcement panel 9 of the A-pillar portion 2. In addition to the A-pillar portion 2, the present disclosure may be applied to an elongated panel such as the B-pillar portion 3, the C-pillar portion 4, the roof rail portion 5, and the side sill portion 6 as long as the panel has a flat general portion extending in the longitudinal direction and a pair of ridgeline forming portions formed by bending two ends of the general portion in the width direction and forming a pair of ridgelines together with the general portion.

In the above-described embodiment, the square seat surface portion 20 has a rectangular shape in a plan view. Alternatively, the square seat surface portion may be formed in a square shape such as a parallelogram shape or a trapezoid shape in a plan view. Further, all seat surfaces formed on the general portion 11 of the elongated vehicle body panel 10 are the square seat surfaces 20. Alternatively, other seat surfaces may be round seat surfaces or the like as long as at least two seat surfaces are square seat surfaces. The number of the square seat surfaces 20 can be freely changed.

Although the embodiment of the present disclosure is described above, the embodiment described above does not limit the disclosures according to the claims. It should be noted that all combinations of features described in the embodiment are not always necessary for means for solving the problems of the disclosure.

According to the elongated vehicle body panel of the embodiment, a state of stress generated in the ridgelines after press working is different in the longitudinal direction between a seat surface forming section in which the square seat surface portion is formed adjacent to the ridgelines and a general section in which the square seat surface portion is not formed. First, in the general section, stress caused by bending the ridgeline forming portions mainly acts on the general portion, and thus tensile stress is generated in the ridgelines. On the other hand, in the seat surface forming section, in addition to bending the ridgeline forming portions, stress caused by the square seat surface portion protruding from the general portion acts on the general portion. Accordingly, compressive stress or tensile stress smaller than that in the general section is generated in the ridgelines. Accordingly, a springback amount after press working can be reduced.

According to the elongated vehicle body panel of the embodiment, after the press working, compressive stress is generated in the seat surface forming section of the ridgelines. Accordingly, tensile stress and compressive stress are alternately generated in the general section and the seat surface forming section of the ridgelines. Accordingly, the section where the tensile stress is generated in the ridgelines can be cut off in the longitudinal direction by the section where the compressive stress is generated, and the springback amount of the elongated vehicle body panel after the bending process can be reduced.

According to the elongated vehicle body panel of the embodiment, compressive stress can be reliably generated in the ridgelines.

According to the elongated vehicle body panel of the embodiment, the outer edge portions of the square seat surface portion in the longitudinal direction are orthogonal to the ridgelines.

According to the disclosure, an elongated vehicle body panel that can reduce a springback amount is provided.

What is claimed is:

1. An elongated vehicle body panel formed by press working, the elongated vehicle body panel comprising:
a flat general portion extending in a longitudinal direction;
a pair of ridgeline forming portions formed by bending two ends of the general portion in a width direction and forming a pair of ridgelines together with the general portion; and
square seat surface portions disposed at an interval in the longitudinal direction on the general portion, each of the square seat surface portions protruding in a thickness direction and having a square shape in a plan view,
wherein the each of the square seat surface portions has a pair of outer edge portions in the width direction that extend along the ridgelines in a vicinity of the ridgelines and a pair of outer edge portions in the longitudinal direction that respectively couple corresponding two ends of the outer edge portions in the width direction.

2. The elongated vehicle body panel according to claim 1,
wherein compressive stress is applied in parts where the square seat surface portions are provided adjacent to the ridgelines respectively.

3. The elongated vehicle body panel according to claim 2,
wherein the each of the square seat surface portions comprises a flat seat surface body at a center in a plan view, and an inclining portion that is provided around the seat surface body and couples the seat surface body and the general portion, and
wherein the seat surface body has a protruding height from the general portion that is greater than a plate thickness of the elongated vehicle body panel.

4. The elongated vehicle body panel according to claim 3,
wherein the each of the square seat surface portions has a rectangular shape in a plan view.

5. A vehicle body structure comprising:
the elongated vehicle body panel according to claim 1; and
a second panel providing a closed section together with the elongated vehicle body panel.

6. A vehicle body structure comprising:
the elongated vehicle body panel according to claim 2; and
a second panel providing a closed section together with the elongated vehicle body panel.

7. A vehicle body structure comprising:
the elongated vehicle body panel according to claim 3; and
a second panel providing a closed section together with the elongated vehicle body panel.

8. A vehicle body structure comprising:
the elongated vehicle body panel according to claim 4; and
a second panel providing a closed section together with the elongated vehicle body panel.

9. An elongated vehicle body panel comprising:
a flat general portion extending in a longitudinal direction;
a first flange portion provided in a first side of the flat general portion in a width direction intersecting the longitudinal direction;
a first ridgeline between the flat general portion and the first flange portion;
a wall portion provided in a second side of the flat general portion in the width direction;
a second ridgeline between the flat general portion and the wall portion; and
square protrusions disposed at an interval in the longitudinal direction on the flat general portion, each of the square protrusions protruding in a thickness direction and having a square shape in a plan view,
wherein the each of the square protrusions has a first outer edge, a second outer edge, and a pair of third and fourth outer edges,
wherein the first outer edge extends along the first ridgeline in a vicinity of the first ridgeline, and the second outer edge extends along the second ridgeline in a vicinity of the second ridgeline, and
wherein the pair of third and fourth outer edges couple corresponding two ends of the first outer edge and second outer edge.
